(19) United States
(12) Patent Application Publication
(10) Pub. No.: US 2003/0103471 A1
(43) Pub. Date: Jun. 5, 2003

(54) Wireless base station

(75) Inventors: Osamu Watanabe, Tokyo (JP); Shinji Ohnishi, Tokyo (JP); Masayuki Sasaki, Tokyo (JP)

Correspondence Address: Sean M. McGinn, McGinn & Gibb, PLLC, Suite 200, 8321 Old Courthouse Road, Vienna, VA, 22182-3817, US

(73) Assignee: Hitachi Kokusai Electric, Inc., Tokyo (JP)

(21) Appl. No.: 10/308,144

(22) Filed: Dec. 3, 2002

(30) Foreign Application Priority Data
Dec. 4, 2001 (JP) 2001-370071

(51) Int. Cl. H04B 7/00

(52) U.S. Cl. 370/310.1; 370/395.1

(57) ABSTRACT

The present invention as disclosed hereby is to provide a wireless base station by which it is possible to readily extend the wireless base station in the number thereof independently of the number of ports of the ATM transmission lines prepared on a wireless network control apparatus. The wireless base station is adapted to be arranged in a cascade connection using an ATM transmission line and comprises: a first transmission line interface means for performing a transmission/reception of an ATM cell to/from a wireless network control apparatus or a superior wireless base station; a second transmission line interface means for performing a transmission/reception of an ATM cell to/from an inferior wireless base station; a control means for controlling the wireless base station; a wireless transmission/reception means for performing a transmission/reception of a radio signal to/from a wireless terminal; and a signal demultiplexing/multiplexing means for transferring an inputted ATM cell to the first transmission line interface means, the second transmission line interface means, the control means or the wireless transmission/reception means according to a header information of the inputted ATM cell.

### BACKGROUND OF THE INVENTION

1. Field of the Invention

The present invention relates to a wireless base station for performing an ATM (Asynchronous Transfer Mode) transmission in a wired communication of the mobile communication system.

2. Description of the Related Art

The following description is provided for explaining that conventional wireless base stations and a wireless network control apparatus are connected to each other with the ATM transmission in a wired communication of a mobile communication system. FIG. 4 is a schematic block diagram showing a connection configuration between the conventional wireless base stations and the wireless network control apparatus as one example. As shown in FIG. 4, the wireless base stations 10 are established in dependence on the number of ports of ATM transmission lines prepared on the wireless network control apparatus 20. In a system of FIG. 4, the wireless network control apparatus 20 is equipped with three ports of the ATM transmission lines so that three units of the wireless base stations 10 are established to conform with the ATM transmission lines. Each of the wireless base stations 10 performs transmission/reception of radio signals between itself and wireless terminal(s).

FIG. 5 is a schematic block diagram showing a configuration of the conventional wireless base station 10. As shown in FIG. 5, the wireless base station 10 comprises: a transmission line interface section 11; a signal demultiplexing/multiplexing section 12; a control section 13; a wireless transmission/reception section 14; and wireless amplifier section 15.

The following description is provided for explaining an operation of the conventional wireless base station 10. The transmission line interface section 11 terminates an ATM transmission line. An ATM cell captured here via a down link is sent to the signal demultiplexing/multiplexing section 12.

The signal demultiplexing/multiplexing section 12 is generally comprised of an ATM switch for switching the ATM cell. The ATM switch includes input/output ports respectively connected to the transmission line interface section 11, the control section 13 and the wireless transmission/reception section 14. This ATM switch performs a transfer of an ATM cell that is inputted thereinto by using one of the input/output ports selected depending on a content of the inputted ATM cell. For example, if the content of the ATM cell inputted from the transmission line interface section 11 is a control signal such as a call control signal, a maintenance monitoring signal or the like, it will be transferred to the control section 13 or if the content thereof is an user signal, it will be transferred to the wireless transmission/reception section 14. Furthermore, if the content of such an inputted ATM cell is a control signal which is restricted within the apparatus, it will be transferred from the control section 13 to the wireless transmission/reception section 14 or from the transmission/reception section 14 to the control section 13. Also, the signal demultiplexing/multiplexing section 12 multiplexes an ATM cell of an user signal received from the wireless transmission/reception section 14 and an ATM cell of a control signal received from the control section 13 to output it to the transmission line interface section 11. Then, the transmission line interface section 11 sends the resultant multiplexed ATM cell to the wireless network control apparatus 20.

In the event that an ATM cell including a control signal has been transferred from the signal demultiplexing/multiplexing section 12 to the control section 13, the control section 13 performs a control according to a control signal received from the wireless network control apparatus 20. In the event that a control signal will be transferred from the control section 13 to the wireless network control apparatus 20, the control section 13 outputs the control signal as an ATM cell to the signal demultiplexing/multiplexing section 12. Furthermore, the control section 13 performs a call control and a condition monitoring in the wireless base station 10.

In the event that the an ATM cell including an user signal has been transferred from the signal demultiplexing/multiplexing section 12 to the wireless transmission/reception section 14, the wireless transmission/reception section 14 takes the user signal out of the ATM cell inputted from the signal demultiplexing/multiplexing section 12 to output to the wireless amplifier section 15 a transmission signal which is obtained by subjecting the user signal to coding and modulation. The wireless amplifier section 15 then amplifies the transmission signal and outputs it outside via an antenna.

In the event that an user signal has been transmitted from an outside wireless terminal to the wireless base station 10, the wireless amplifier section 15 outputs an reception signal which is received via the antenna and amplified to the wireless transmission/reception section 14. The wireless transmission/reception section 14 performs demodulation, decoding and decomposing of the reception signal to obtain an user signal and creates an ATM cell by using the user signal, thereby outputting it to the signal demultiplexing/multiplexing section 12.

Subsequently, the following description is provided for explaining an operation that the conventional wireless base station 10 synchronizes a system clock of its own station with that of the wireless network control apparatus 20.

Among various transmission line interface sections 11 of the wireless base stations 10, there is one capable of synchronizing a system clock of its wireless base station with that of the wireless network control apparatus 20. This transmission line interface section 11 generates a system clock by using a PLL circuit (not shown) on a basis of a received clock extracted from a signal received from the wireless network control apparatus 20. The conventional wireless base station 10 operates in such a manner as above.

However, in the case of the conventional connection relation between the wireless network control apparatus and the wireless base stations, only one wireless base station is exclusively connected to one of ports of the ATM transmissions prepared on the wireless network control apparatus. For that reason, there is occurred a restriction in view of hardware implementation in that the number of wireless base stations connected to a single wireless network control apparatus is limited to the number of the ports of the ATM transmission lines prepared on the wireless network control apparatus. When an increase in the number of the wireless base stations is desired, it is necessary to draw a new ATM transmission line from the wireless network control apparatus or to establish a new wireless network control apparatus, thereby disadvantageously costing a great deal.

The present invention has been accomplished in consideration of these and other problems and is intended as a purpose to provide a wireless base station by which it is possible to readily extend the wireless base station in the number thereof independently of the number of ports of the ATM transmission lines prepared on a wireless network control apparatus.

### SUMMARY OF THE INVENTION

In order to achieve the above-mentioned object, there is provided a wireless base station adapted to be arranged in a cascade connection using an ATM transmission line, characterized by comprising:

a first transmission line interface means for performing a transmission/reception of an ATM cell to/from a wireless network control apparatus or a superior wireless base station;

a second transmission line interface means for performing a transmission/reception of an ATM cell to/from an inferior wireless base station;

a control means for controlling said wireless base station;

a wireless transmission/reception means for performing a transmission/reception of a radio signal to/from a wireless terminal; and

a signal demultiplexing/multiplexing means for transferring an inputted ATM cell to said first transmission line interface means, said second transmission line interface means, said control means or said wireless transmission/reception means according to a header information of said inputted ATM cell.

With this configuration, it is possible to readily extend the wireless base station in the number thereof by arranging a plurality of similar wireless base stations in a cascade connection.

Also, in the wireless base station according to the present invention, said control means is characterized by comprising: a transmission-line monitoring means for detecting a condition change in an ATM transmission line connected to said second transmission line interface means; and a transmission-line monitoring information generating means for generating an ATM cell of said condition change and transmitting it to said wireless network control apparatus.

With this configuration, it is possible for said wireless network control apparatus to monitor condition changes in ATM transmission lines among all of said wireless base stations arranged in a cascade connection.

Furthermore, in the wireless base station according to the present invention, said first transmission line interface means is capable of transmitting a clock extracted from reception of an ATM cell to said second transmission line interface means and, in response to that transmission, said second transmission line interface means generates a system clock of said wireless base station by using said clock and performs a transmission of an ATM cell.

With this configuration, it is possible to dependently synchronize each system clock of all wireless base stations arranged in a cascade connection with a system clock of the wireless network control apparatus.

### BRIEF DESCRIPTION OF THE DRAWINGS

FIG. 1 is a schematic block diagram showing a connection configuration example between a wireless network control apparatus and wireless base stations according to an embodiment of the present invention;

FIG. 2 is a schematic block diagram showing a configuration example of the wireless base station according to the embodiment of the present invention;

FIG. 3 is a schematic block diagram showing a portion of a control section in the wireless base station according to the embodiment of the present invention;

FIG. 4 is a schematic block diagram showing a connection configuration example between a wireless network control apparatus and conventional wireless base stations; and

FIG. 5 is a schematic block diagram showing a configuration example of the conventional wireless base station.

### PREFERRED EMBODIMENT OF THE PRESENT INVENTION

Hereinafter, a preferred embodiment of the present invention will be described in detail with reference to the accompanying drawings.

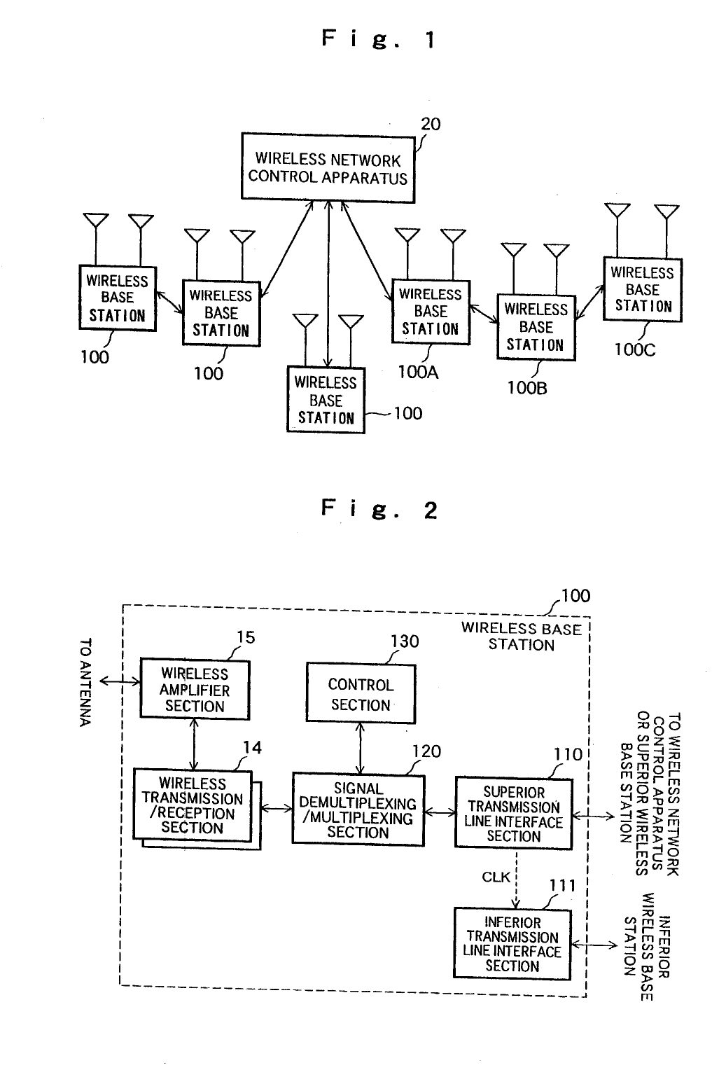

FIG. 1 is a schematic block diagram showing a connection configuration example between a wireless network control apparatus 20 and wireless base stations 100 according to an embodiment of the present invention. As shown in FIG. 1, one of ATM transmission lines drawn from the wireless network control apparatus 20 is connected to the wireless base station 100 from which a plurality of similar wireless base stations are cascade-connected or arranged in a cascade connection. Hereinafter, among these wireless base stations 100 arranged in a cascade connection, one which is closer to the wireless network control apparatus 20 or otherwise the wireless network control apparatus 20 itself is referred to as a “superior station” and one which is farther from the wireless network control apparatus 20 is referred to as an “inferior station”.

For example, there is shown in FIG. 1 three wireless base stations 100 arranged in a cascade connection, i.e., a wireless base station 100A which is directly connected to the wireless network control apparatus 20, a wireless base station 100B which serves as an inferior station to the wireless base station 100A and connected thereto, and a wireless base station 100C which serves as an inferior station to the wireless base station 100B and connected thereto. Each of these wireless base stations 100A, 100B and 100C is similar in configuration and operation to those of the wireless base station 100. Of course, a further cascade-connection arrangement of the wireless base stations can be added to the above cascade arrangement without being limited to the FIG. 1 configuration.

The following description is provided for explaining a configuration and an operation of the wireless base station 100 according to an embodiment of the present invention. FIG. 2 is a schematic block diagram showing a configuration example of the wireless base station. In FIGS. 2 and 5, like reference numbers indicate like elements and therefore explanations of the like elements are omitted hereinafter.

The wireless base station 100 comprises: a wireless amplifier section 15 coupled to an antenna; a wireless transmission/reception section 14; a signal demultiplexing/multiplexing section 120; a control section 130; a superior transmission line interface section 110 which performs a transmission/reception of ATM cells to/from a superior station; and an inferior transmission line interface section 111 which performs a transmission/reception of an ATM cell to/from an inferior station, wherein in particular the latter two sections (110 and 111) are installed instead of the transmission line interface section 11 of FIG. 5. The superior transmission line interface section 110 has one end connected to the signal demultiplexing/multiplexing section 120 and another end connected to a superior station. The inferior transmission line interface section 111 has one end connected to the signal demultiplexing/multiplexing section 120 and another end connected to an inferior station. Besides controlling operations as performed by the conventional control section 13, the control section 130 is additionally capable of controlling the communications to other base stations and reporting condition changes in the transmission lines to the wireless network control apparatus 20. In this embodiment, the superior transmission line interface section 110 is also referred to as first transmission line interface means, the inferior transmission line interface section 111 is also referred to as second transmission line interface means, the control section 130 is also referred to as control means, the wireless transmission/reception section 14 and wireless amplifier sections 14 and 15 are collectively referred to as wireless transmission/reception means, and the signal demultiplexing/multiplexing section 120 is also referred to as signal demultiplexing/multiplexing means.

The following description is provided for explaining operations of the superior transmission line interface section 110, the inferior transmission line interface section 111 and the signal demultiplexing/multiplexing section 120.

First of all, an ATM cell which has been sent from a superior station to the wireless base station 100 is received by the superior transmission line interface section 110 and then outputted to the signal demultiplexing/multiplexing section 120. On the other hand, an ATM cell which has been sent from an inferior station to the wireless base station 100 is received by the inferior transmission line interface section 111 and then outputted to the signal demultiplexing/multiplexing section 120.

In particular, a VPI (Virtual Path ID) and VCI (Virtual Channel ID) are included in a header information of each ATM cell. To the VPI and VCI are previously assigned a wireless base station as a destination for the ATM cell through the wireless network control apparatus 20. For example, to a VPI of an ATM cell destined to the wireless base station 100A is assigned “0”, to a VPI of an ATM cell destined to the wireless base station 100B is assigned “1”, and to a VPI of an ATM cell destined to the wireless base station 100C is assigned “2”.

In a similar manner to the conventional signal demultiplexing/multiplexing section, the signal demultiplexing/multiplexing section 120 is generally comprised of an ATM switch for switching an ATM cell. In particular, this ATM switch includes input/output ports respectively connected to the superior transmission line interface section 110, the inferior transmission line interface section 111, the controller section 130 and the wireless transmission/reception section 14. This ATM switch performs a transfer of an ATM cell which is inputted thereinto by using one of the input/output ports selected depending on a VPI and a VCI of the inputted ATM cell.

For example, if an inputted ATM cell has a VPI of “1”, the signal demultiplexing/multiplexing section 120 in the wireless base station 100B regards it as the ATM cell destined to the wireless base station 100B and outputs it to the control section 130 or the wireless transmission/reception section 14 because that ATM cell is destined to its own station (the wireless base station 100B). As another example, if an inputted ATM cell has a VPI of “0”, the signal demultiplexing/multiplexing section 120 in the wireless base station 100B regards it as the ATM cell destined to the wireless base station 100A and outputs it to the superior transmission line interface section 110 because that ATM cell is destined to a superior station to the wireless base station 100B. As yet another example, if an inputted ATM cell has a VPI of “2”, the signal demultiplexing/multiplexing section 120 in the wireless base station 100B regards it as the ATM cell destined to the wireless base station 100C and outputs it to the inferior transmission line interface section 111 because that ATM cell is destined to an inferior station to the wireless base station 100B.

Subsequently, the superior transmission line interface section 110 will send the ATM cell from the signal demultiplexing/multiplexing section 120 to the superior station. On the other hand, the inferior transmission line interface section 111 will send the ATM cell from the signal demultiplexing/multiplexing section 120 to the inferior station. In this manner, the present invention enables a transmission/reception of an ATM cell to be conducted among the wireless network control apparatus 20 and the wireless base stations 100A, 100B, 100C connected in a cascade connection with respect to the wireless network control apparatus 20.

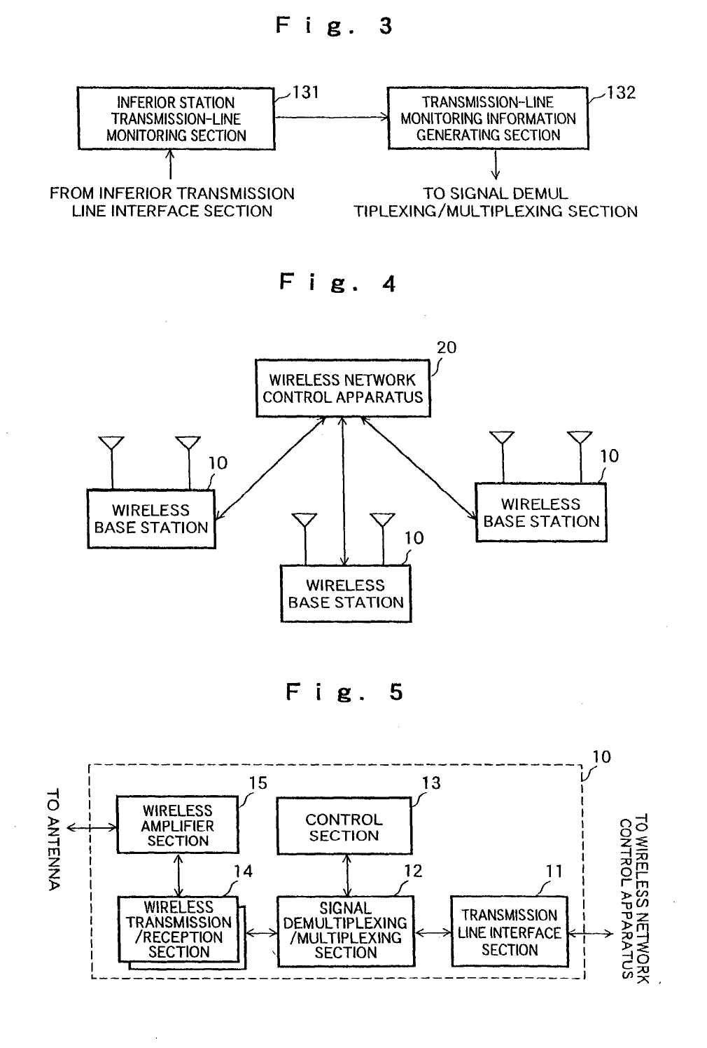

Next, the following description is provided for explaining an operation of the control section 130. The control section 130 is capable of reporting to the wireless network control apparatus 20 condition changes in the transmission lines among the wireless base stations. FIG. 3 is a schematic block diagram showing a portion of the control section in the wireless base station according to the embodiment of the present invention. This control section 130 comprises: an inferior station transmission-line monitoring section 131 and a transmission-line monitoring information generating section 132. In this embodiment, the inferior station transmission-line monitoring section 131 is also referred to as transmission-line monitoring means and the transmission-line monitoring information generating section 132 is referred to as transmission-line monitoring information generating means.

In the event that a plurality of the wireless base stations are cascade-connected from one to anther as shown in FIG. 1, a condition change only in the transmission line between the wireless network control apparatus 20 and the wireless base station 100A directly connected to the former can be monitored by the wireless network control apparatus 20, but a condition change in such a transmission line with respect to each of the wireless base stations arranged in a cascade connection behind the wireless base station 100A is monitored at the most on a level of conductivity verification using F4-OAM.

The inferior station transmission-line monitoring section 131 detects a condition change in the transmission line of the inferior station by using information such as, a signal interruption, a frame synchronism deviation, a cell synchronism deviation and a quality deterioration outputted from the inferior transmission line interface section 111. The transmission-line monitoring information generating section 132 converts the condition change detected by the inferior station transmission-line monitoring section 131 into an ATM cell and outputs it to the signal demultiplexing/multiplexing section 120 to report it as the condition change to the wireless network control apparatus 20. At this time, the ATM cell to be sent may be previously assigned to any VPI/VCI unique thereto and be applied to with any signal format. In this manner, the present invention enables the wireless network control apparatus 20 to monitor a condition change in each ATM transmission line among all wireless base stations arranged in a cascade connection.

The following description is provided for explaining an operation by which each of the wireless base stations 100A, 100B, 100C arranged in a cascade connection synchronizes its own system clock with that of the wireless network control apparatus 20. The superior transmission line interface section 110 extracts a reception clock from a signal received from its superior station. Then, the reception clock extracted by the superior transmission line interface section 110 is transmitted to the inferior transmission line interface section 111 along a route of dotted line having an arrow directed from the superior transmission line interface section 110 to the inferior transmission line interface section 111 as shown in FIG. 2. The inferior transmission line interface section 111 generates a system clock to be sent to an inferior station by using the reception clock transmitted thereinto as a standard. In particular, it would be appreciated that a procedure for generating a system clock by using a certain clock as a standard can be readily implemented by a well-known device. In this manner, the present invention enables each of the wireless base stations 100A, 100B, 100C arranged in a cascade connection to synchronize its own system clock with that of the wireless network control apparatus 20, by the provision of such a route as to transmit the reception clock extracted by the superior transmission line interface section 110 to the inferior transmission line interface section 111 therealong.

It would be appreciated to a person skilled in the art that the superior transmission line interface section 110 according to this embodiment is convertible to the inferior transmission line interface section 111.

In this embodiment, the control section 130 is configured to perform a transmission/reception operation of a control signal from the wireless network control apparatus 20 other than a call controlling and a condition monitoring operations within its own station and associated controlling operations of various sections. Specifically, since the ATM cell is routed transmissively to respective inferior stations arranged in a cascade connection as described above, there is no inconvenience raised in transmission/reception of a signal due to such a cascade connection arrangement. The wireless transmission/reception section 14 and the wireless amplifier section 15 in this embodiment may be configured in a similar manner as the conventional ones without any additional processing operation.

As described above, it is possible to readily extend the wireless base station in the number thereof by arranging a plurality of similar wireless base stations in a cascade connection without laying additional ATM transmission lines drawn from the wireless network control apparatus and establishing additional wireless network control apparatuses. As a result, it can provide a cost reduction in association with an extension of additional wireless base stations. Furthermore, according to the present invention, in the event that a counter measure for increasing the number of sectors is performed to increase accommodated users, it is possible to readily extend the wireless base station in the number thereof and also possible to implement quasi sectors by establishing a plurality of wireless base stations in the same area and allocating a directivity of each wireless base station to different direction from other wireless base station.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A wireless base station adapted to be arranged in a cascade connection using an ATM transmission line, comprising:
a first transmission line interface means for performing a transmission/reception of an ATM cell to/from a wireless network control apparatus or a superior wireless base station;
a second transmission line interface means for performing a transmission/reception of an ATM cell to/from an inferior wireless base station;
a control means for controlling said wireless base station;
a wireless transmission/reception means for performing a transmission/reception of a radio signal to/from a wireless terminal; and
a signal demultiplexing/multiplexing means for transferring an inputted ATM cell to said first transmission line interface means, said second transmission line interface means, said control means or said wireless transmission/reception means according to a header information of said inputted ATM cell.

2. A wireless base station as claimed in claim 1, wherein said control means comprises: a transmission-line monitoring means for detecting a condition change in an ATM transmission line connected to said second transmission line interface means; and a transmission-line monitoring information generating means for generating an ATM cell of said condition change and transmitting it to said wireless network control apparatus.
